(19) United States
(12) Patent Application Publication
(10) Pub. No.: US 2014/0049820 A1
(43) Pub. Date: Feb. 20, 2014

(54) Dual Projection System

(71) Applicant: Jin Won KIM, Los Angeles, CA (US)

(72) Inventor: Jin Won KIM, Los Angeles, CA (US)

(21) Appl. No.: 13/588,324

(22) Filed: Aug. 17, 2012

(51) Int. Cl. G03B 21/62

(52) U.S. Cl. 359/449

(57) ABSTRACT

A dual projection system includes a projector, a partially transparent white film, and a partially transparent black film. The still or motion image from the projector is projected directly on the partially transparent white film. The partially transparent black film is disposed behind the partially transparent white film with an gap. The partially transparent white film reflects and displays a first portion of the still or motion image thereon for a first observer inside. The partially transparent black film allows a second portion of the still or motion image transmitted through the partially transparent white film transmitted therethrough for a second observer outside.

### BACKGROUND OF THE INVENTION

The present invention relates to a dual projection system. More particularly, this invention relates to a dual projection system, which can be observed on both sides of a window pane.

A window is not only for inviting external look or light inside, but also for exposing the inside to outside.

However, sometimes due to drastic difference in brightness of the inside and the outside, the purposes of the above are compromised seriously.

Therefore, it may be desirable if we can compensate the drastic difference in brightness of the inside and the outside and further directional complications light reflection and transmission.

Accordingly, a need for a dual projection system for a show window has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a dual projection system, which can display image that is visible to observers inside and outside of the window pane.

An aspect of the present invention provides a dual projection system comprising a projector, a partially transparent white film, and a partially transparent black film.

The projector is for projecting still or motion image toward a first direction.

The partially transparent white film on which the still or motion image from the projector is projected directly is disposed in front of the projector.

The partially transparent black film is disposed behind the partially transparent white film with an gap of a predetermined thickness.

The partially transparent white film is configured to reflect and display a first portion of the still or motion image thereon for a first observer who is in front of the partially transparent white film on the same side as the projector.

The partially transparent black film is configured to allow a second portion of the still or motion image transmitted through the partially transparent white film thereon to be transmitted therethrough for a second observer on the opposite side to the projector.

During a daytime the partially black film is configured to absorb substantial portion of external light from outside so as not to be reflected toward outside, such that the brightness of the second portion of the still or motion image is high enough for the second observer, not obscured by the reflected external light.

During a nighttime the partially transparent black film is configured to reflect a predetermined portion of the second portion of light from inside through the partially transparent white film toward the partially transparent white film, such that the brightness of the second portion of the still or motion image is reduced by a predetermined amount for the second observer.

The projector may produce the still or motion image of brightness between about 3500 lumens to about 8000 lumens.

The partially transparent white film may be configured to transmit the light therethrough with a first transmission rate of about 35 percent to about 80 percent.

The first transmission rate may be determined by the relative brightness of the inside and the outside depending on a location where the dual projection system is installed.

The partially transparent white film may comprise a white based matte film or a white based frost film.

The partially transparent black film may be configured to transmit the light therethrough with a second transmission rate of about 15 percent to about 70 percent.

The second transmission rate may be determined by the relative brightness of the inside and the outside depending on a location where the dual projection system is installed.

The partially transparent black film may comprise a black based film.

The predetermined thickness of the gap between the partially transparent white film and the partially transparent black film may be substantially zero, such that the partially transparent white film may be attached directly to the partially transparent black film.

The partially transparent white film may be attached directly to the partially transparent black film with glue or other fixing means.

A sheet of glass pane may be disposed in front of the partially transparent white film. The partially transparent white film may be attached to the sheet of glass pane with glue.

Alternatively, the sheet of glass pane may be disposed behind the partially transparent black film. In this case, the partially transparent black film may be attached to the sheet of glass pane with glue.

Still alternatively, the sheet of glass pane may be disposed in the gap of the predetermined thickness between the partially transparent white film and the partially transparent black film.

Each of the partially transparent white film and the partially transparent black film may be attached to the sheet of glass pane with glue or other fixing means.

The advantages of the present invention are: (1) the dual projection system can be used on a regular window pane easily; and (2) the dual projection system can improve visibility of image projected on to the window pane irrespective of day or night.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic diagram showing a dual projection system during a nighttime according to an embodiment of the present invention;

FIG. 2 is a schematic diagram showing a dual projection system during a daytime according to another embodiment of the present invention;

FIG. 3 is a perspective view showing three different dual projection systems according to still another embodiments of the present invention;

FIG. 4 is a side view showing a white film and a black film according to still another embodiments of the present invention;

FIG. 5 is a side view showing a white film, a black film, and a window pane according to still another embodiments of the present invention;

FIG. 6 is a side view showing a white film, a black film, and a window pane according to still another embodiments of the present invention; and

FIG. 7 is a side view showing a white film, a black film, and a window pane according to still another embodiments of the present invention.

### DETAILED DESCRIPTION EMBODIMENTS OF THE INVENTION

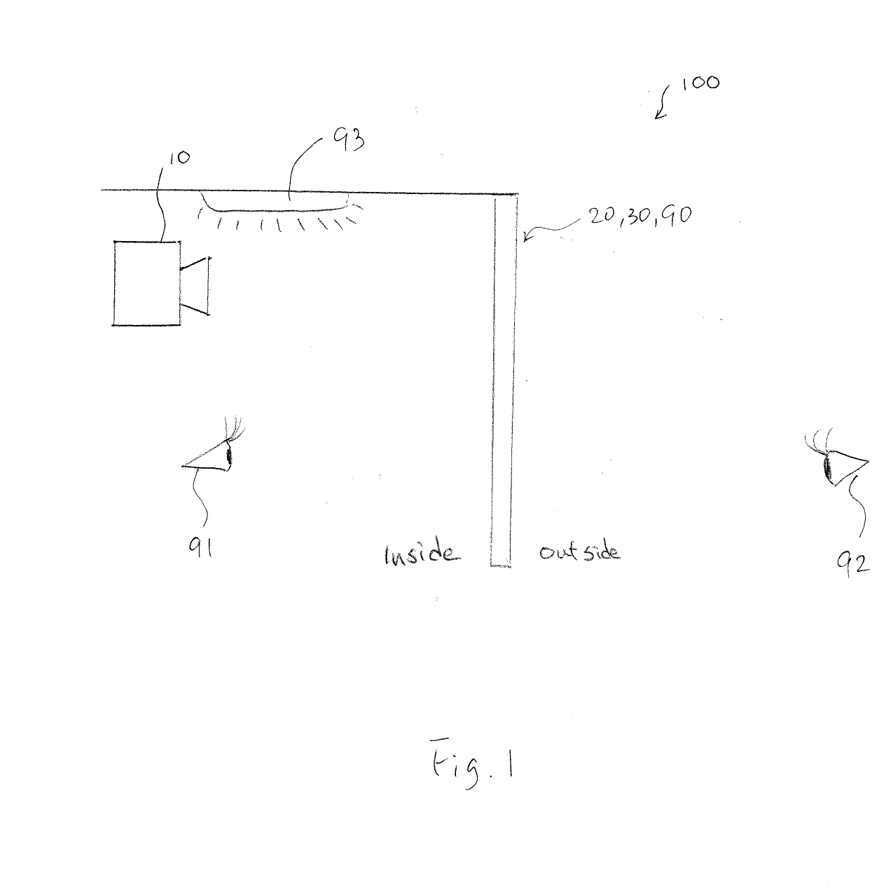

An object of the invention is to provide a dual projection system 100, which can display image 12 that is visible to observers 91, 92 inside and outside of the window pane 90 as shown in FIGS. 1-3.

An aspect of the present invention provides the dual projection system 100 comprising a projector 10, a partially transparent white film 20, and a partially transparent black film 30.

The projector 10 is for projecting still or motion image 12 toward a first direction, from the inside to the outside, as shown in FIGS. 1-3.

The partially transparent white film 20 on which the still or motion image 12 from the projector 10 is projected directly is disposed in front of the projector 10.

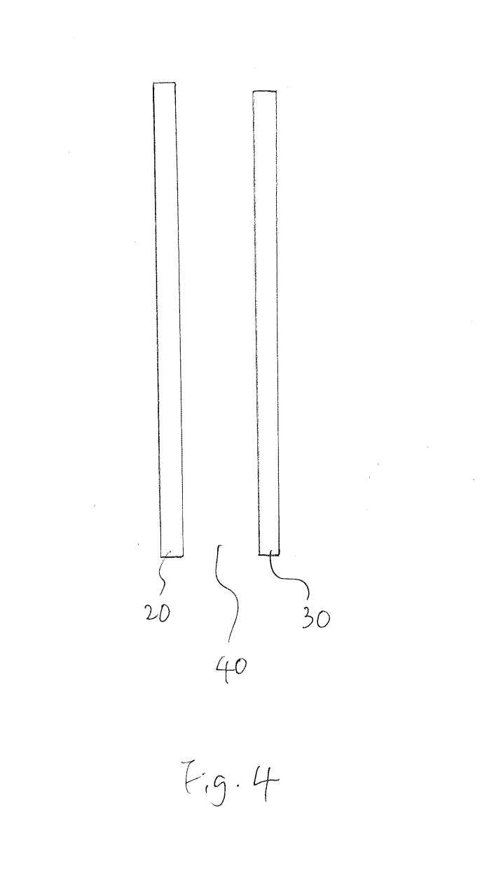

The partially transparent black film 10 is disposed behind the partially transparent white film 20 with an gap 40 of a predetermined thickness as shown in FIG. 4.

The partially transparent white film 20 is configured to reflect and display a first portion of the still or motion image 12 thereon for a first observer 91 who is in front of the partially transparent white film 20 on the same side as the projector 10.

The partially transparent black film 30 is configured to allow a second portion of the still or motion image 12 transmitted through the partially transparent white film 20 thereon to be transmitted therethrough for a second observer 92 on the opposite side to the projector 10.

During a daytime the partially black film is configured to absorb substantial portion of external light from outside so as not to be reflected toward outside, such that the brightness of the second portion of the still or motion image 12 is high enough for the second observer 92.

During a nighttime the partially transparent black film 30 is configured to reflect a predetermined portion of the second portion of light from inside through the partially transparent white film 20 toward the partially transparent white film 20, such that the brightness of the second portion of the still or motion image 12 is reduced by a predetermined amount for the second observer 92.

The projector 10 may produce the still or motion image 12 of brightness between about 3500 lumens to about 8000 lumens.

The partially transparent white film 20 may be configured to transmit the light therethrough with a first transmission rate of about 35 percent to about 80 percent.

The first transmission rate may be determined by the relative brightness of the inside and the outside depending on a location where the dual projection system 100 is installed. For example, if the first transmission rate may be determined or chosen according to where the dual projection system 100 is installed, in a south side or a north side of a building.

The partially transparent white film 20 may comprise a white based matte film or a white based frost film.

The partially transparent black film 30 may be configured to transmit the light therethrough with a second transmission rate of about 15 percent to about 70 percent.

The second transmission rate may be determined by the relative brightness of the inside and the outside depending on a location where the dual projection system 100 is installed as explained in the above.

The partially transparent black film 30 may comprise a black based film.

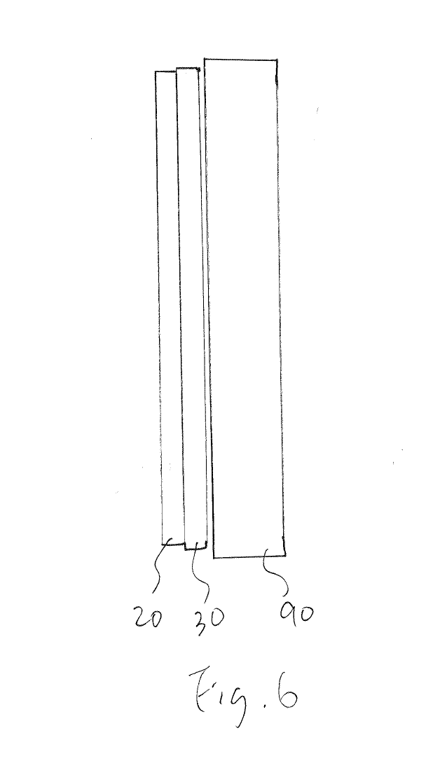

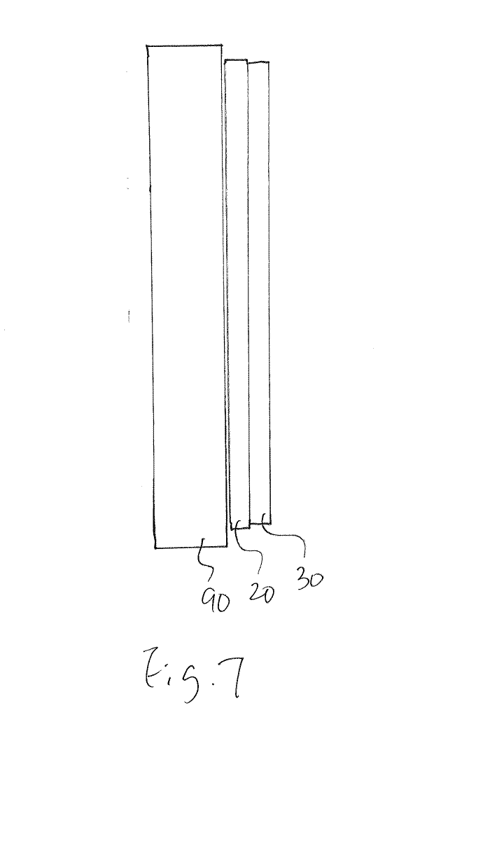

The predetermined thickness of the gap 40 between the partially transparent white film 20 and the partially transparent black film 30 may be substantially zero, such that the partially transparent white film 20 may be attached directly to the partially transparent black film 30 as shown in FIGS. 6 and 7.

The partially transparent white film 20 may be attached directly to the partially transparent black film 30 with glue or other fixing means.

A sheet of glass pane 90 may be disposed in front of the partially transparent white film 20. The partially transparent white film 20 may be attached to the sheet of glass pane 90 with glue.

Alternatively, the sheet of glass pane 90 may be disposed behind the partially transparent black film 30. In this case, the partially transparent black film 30 may be attached to the sheet of glass pane 90 with glue.

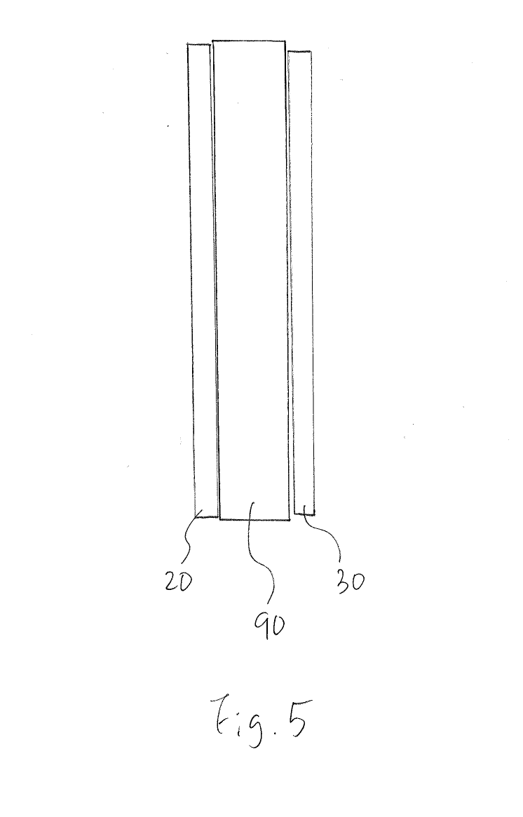

Still alternatively, the sheet of glass pane 90 may be disposed or inserted in the gap 40 of the predetermined thickness between the partially transparent white film 20 and the partially transparent black film 30 as shown in FIG. 5.

Each of the partially transparent white film 20 and the partially transparent black film 30 may be attached to the sheet of glass pane 90 with glue or other fixing means.

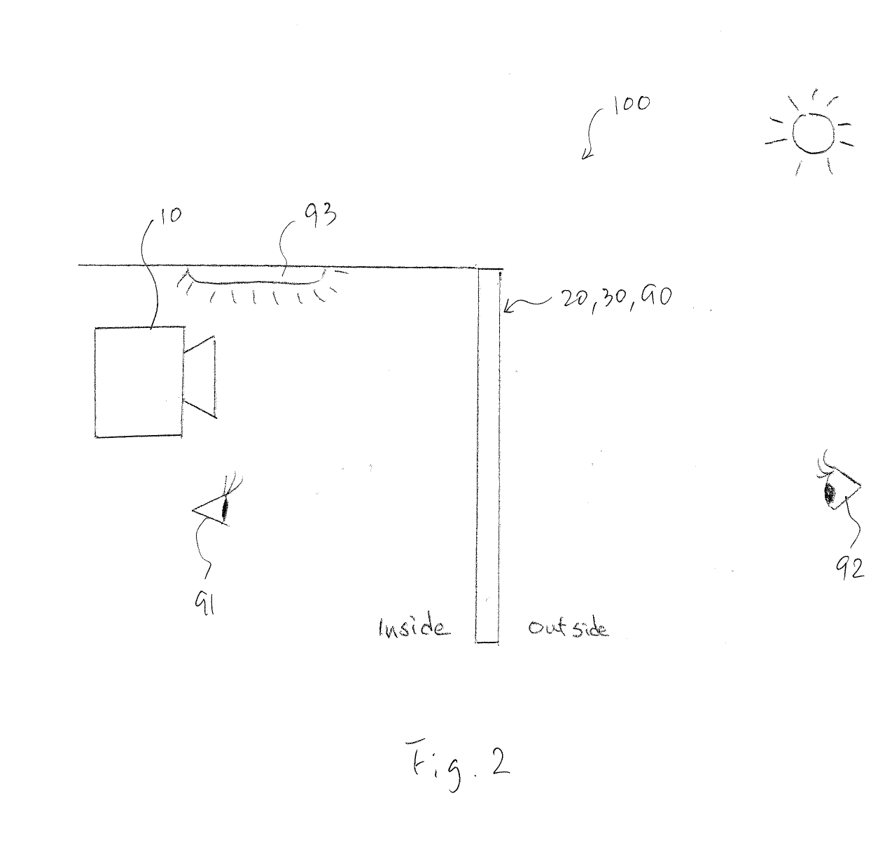

In FIGS. 1 and 2, the inside of the window pane 90 may be illuminated by a lamp 93. During the daytime, the light from the lamp 93 is of course much dimmer than the external light from the outside.

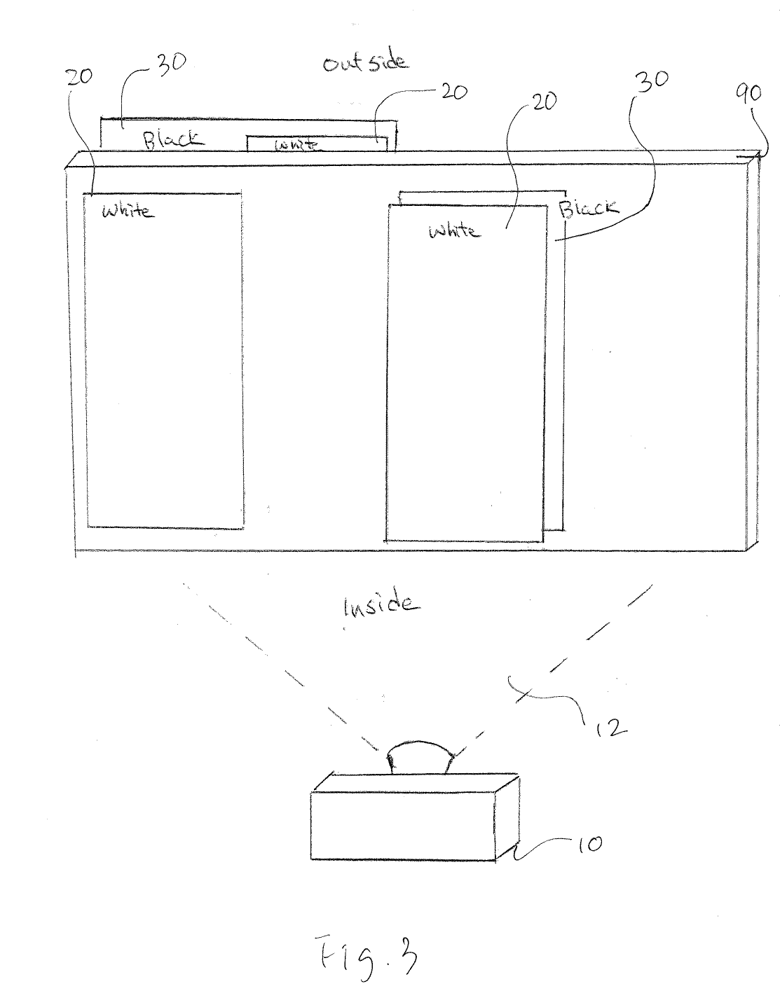

FIG. 3 shows three different relative dispositions of the partially transparent white film 20 and the partially transparent black film 30 with respect to the window pane 90. On the leftmost of the window pane 90, the window pane is sandwiched between the two films 20, 30. In the middle, the two films 20, 30 are disposed on the outside of the window pane 90. And on the rightmost, the two films 20, 30 are disposed on the inside of the window pane 90.

In FIGS. 4-7, even though there is another gap between the films 20, 30 and the window pane 90, it is just for showing them separately, and they may be attached with glue without any gap in a real installation.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A dual projection system comprising:
a projector for projecting still or motion image toward a first direction;
a partially transparent white film on which the still or motion image from the projector is projected directly; and
a partially transparent black film disposed behind the partially transparent white film with an gap of a predetermined thickness,
wherein the partially transparent white film is configured to reflect and display a first portion of the still or motion image thereon for a first observer who is in front of the partially transparent white film on the same side as the projector,
wherein the partially transparent black film is configured to allow a second portion of the still or motion image transmitted through the partially transparent white film thereon to be transmitted therethrough for a second observer on the opposite side to the projector,
wherein during a daytime the partially black film is configured to absorb substantial portion of external light from outside so as not to be reflected toward outside, such that the brightness of the second portion of the still or motion image is high enough for the second observer, and
wherein during a nighttime the partially transparent black film is configured to reflect a predetermined portion of the second portion of light from inside through the partially transparent white film toward the partially transparent white film, such that the brightness of the second portion of the still or motion image is reduced by a predetermined amount for the second observer.

2. The dual projection system of claim 1, wherein the projector produces the still or motion image of brightness between about 3500 lumens to about 8000 lumens.

3. The dual projection system of claim 1, wherein the partially transparent white film is configured to transmit the light therethrough with a first transmission rate of about 35 percent to about 80 percent.

4. The dual projection system of claim 3, wherein the first transmission rate is determined by the relative brightness of the inside and the outside depending on a location where the dual projection system is installed.

5. The dual projection system of claim 3, wherein the partially transparent white film comprises a white based matte film or a white based frost film.

6. The dual projection system of claim 1, wherein the partially transparent black film is configured to transmit the light therethrough with a second transmission rate of about 15 percent to about 70 percent.

7. The dual projection system of claim 6, wherein the second transmission rate is determined by the relative brightness of the inside and the outside depending on a location where the dual projection system is installed.

8. The dual projection system of claim 6, wherein the partially transparent black film comprises a black based film.

9. The dual projection system of claim 1, wherein the predetermined thickness of the gap between the partially transparent white film and the partially transparent black film is substantially zero, such that the partially transparent white film is attached directly to the partially transparent black film.

10. The dual projection system of claim 9, wherein the partially transparent white film is attached directly to the partially transparent black film with glue.

11. The dual projection system of claim 9, wherein a sheet of glass pane is disposed in front of the partially transparent white film.

12. The dual projection system of claim 11, wherein the partially transparent white film is attached to the sheet of glass pane with glue.

13. The dual projection system of claim 9, wherein a sheet of glass pane is disposed behind the partially transparent black film.

14. The dual projection system of claim 13, wherein the partially transparent black film is attached to the sheet of glass pane with glue.

15. The dual projection system of claim 1, wherein a sheet of glass pane is disposed in the gap of the predetermined thickness between the partially transparent white film and the partially transparent black film.

16. The dual projection system of claim 15, wherein each of the partially transparent white film and the partially transparent black film is attached to the sheet of glass pane with glue.
